(19) United States
(12) Patent Application Publication
(10) Pub. No.: US 2008/0023334 A1
(43) Pub. Date: Jan. 31, 2008

(54) Liquid Treatment Apparatus

(75) Inventors: Sota Nakagawa, Tokyo (JP); Masaji Akahori, Tokyo (JP); Makoto Kashiwagi, Tokyo (JP); Yuji Sasaki, Tokyo (JP)

Correspondence Address: WENDEROTH, LIND & PONACK, L.L.P., 2033 K STREET N. W., SUITE 800, WASHINGTON, DC, 20006-1021, US

(73) Assignee: EBARA CORPORATION, TOKYO (JP)

(21) Appl. No.: 11/629,792

(22) PCT Filed: Jun. 16, 2005
(86) PCT No.: PCT/JP05/11478

§ 371 Date: Dec. 15, 2006

(30) Foreign Application Priority Data
Jun. 18, 2004 (JP) 2004-181861

(51) Int. Cl. B01D 61/48; C02F 1/469

(52) U.S. Cl. 204/632

(57) ABSTRACT

A liquid treatment apparatus includes a cathode chamber (4) having a cathode (7), an anode chamber (1) having an anode (6), a deionization chamber (2) disposed between the cathode chamber (4) and the anode chamber (1), and a neutralization chamber (3) disposed between the cathode chamber (4) and the anode chamber (1). The deionization chamber is configured to selectively remove cations or anions from a water to be treated and receive ions having the same charge as the selectively removed ions from the cathode chamber (4) or the anode chamber (1). The neutralization chamber is configured to receive the removed ions and electrically neutralize the removed ions by ions supplied from the anode chamber (1) or the cathode chamber (4). An ion exchange membrane is provided to partition the deionization chamber and the neutralization chamber.

### TECHNICAL FIELD

The present invention relates to a liquid treatment apparatus, and more particularly to a liquid treatment apparatus for separating cations, such as copper ions or ammonium ions, or anions, such as fluoride ions or sulfate ions, from a liquid to be treated. The present invention also relates to a fluorine treatment system for treating fluorine using such a liquid treatment apparatus.

### BACKGROUND ART

When industrial waste water (e.g., waste water discharged from semiconductor device fabrication processes) is to be treated, it may be required to remove or recover cations, such as metal ions or ammonium ions, or anions, such as fluoride ions or sulfate ions from the viewpoint of material recycling.

For example, demands for finer interconnections have recently increased in fabrication processes for semiconductor devices such as semiconductor integrated circuits. Accordingly, problematical signal delay due to interconnection resistance becomes significant. In order to solve such a drawback, copper is used for interconnections instead of aluminum or tungsten. Semiconductor device fabrication processes including as an electrolytic copper plating process, an electroless copper plating process, a chemical mechanical polishing process (CMP), and an electrochemical polishing process (ECP) for microchips having integrated circuits produce a large amount of waste water containing copper ions. With respect to an allowable limit of copper ions contained in waste water, the maximum concentration of copper ions is restricted to 3.0 mg/l or less in Japan. In the United States, the maximum concentration of copper is strictly limited. For example, the maximum concentration of copper is restricted to 2.7 mg/l or less, an average concentration of copper ions per day is restricted to 1.0 mg/l or less, and an average concentration of copper ions per year is restricted to 0.4 mg/l or less.

Generally, waste water discharged from a CMP process or a copper plating process has a copper concentration of 100 mg/l or less. Because high operation voltages are required to recover copper from such waste water, electrodialysis or electrolytic deposition has not been employed to recover copper from waste water. According to an ion exchange resin method, copper ions are adsorbed and recovered by ion exchange resin. Thus, further treatment is required to reuse the recovered copper. Furthermore, frequency of replacement of ion exchange resin is increased to cause troublesome work. According to a coagulation-sedimentation method, copper is precipitated and recovered in the form of hydroxide or oxide. Thus, further treatment is required to reuse the recovered copper. Accordingly, from the viewpoint of environmental protection and resources saving, there has been desired an apparatus capable of efficiently recovering cations such as copper ions in a concentrated state, which can readily be recycled, from waste water.

Further, semiconductor fabrication processes produce waste water containing hydrofluoric acid or waste water containing buffered hydrofluoric acid (hydrofluoric acid+ammonium fluoride). Such waste water has heretofore been treated by a coagulation-sedimentation apparatus. However, the coagulation-sedimentation apparatus produces a large amount of sludge mainly including calcium fluoride and a flocculating agent for flocculating calcium fluoride. The produced sludge is not readily recycled. Because fluorine is one of rare resources and is maldistributed in China and Mongolia, there has been desired an apparatus capable of recycling fluorine. Furthermore, if unnecessary ammonia is removed from waste water containing buffered hydrofluoric acid, hydrofluoric acid can be reused. Accordingly, there has also been desired an apparatus capable of selectively removing ammonia from waste water.

Further, a plating solution containing sulfuric acid is used in a semiconductor fabrication process, an electronic component fabrication process, and an electrode fabrication process. In these processes, conditions of a plating bath are selected according to an intended use so as to determine the thickness or properties of a resultant plated film. There has been known to one having ordinary skill in the art that properties of a resultant plated film are correlated not only with a concentration of metal ions but also with a concentration of sulfuric acid. Metal ions are deposited and consumed on a surface of an object being plated. The concentration of liberated sulfuric acid becomes high relative to the concentration of metal ions. Accordingly, plating efficiency and quality are lowered. When plating is continuously conducted, periodic analysis of components in a plating bath and various adjustments of a plating solution are generally performed to manage the plating solution. If sulfate ions, which have an increased concentration, can be removed, management of a plating solution is facilitated. Accordingly, there has been desired an apparatus capable of selectively removing excessive sulfate ions from a plating solution.

When concentrated water which has been recovered or water from which unnecessary components have been removed is to be reused, a lowered concentration of impurities contained in the water is advantageous in that cost for recycling can be reduced. Accordingly, there has been desired an apparatus capable of removing or concentrating only a desired substance with avoiding contamination or concentration of impurities.

In this regard, a conventional electrodialysis apparatus has demineralization chambers and concentration chambers which are alternately arranged. Waste water is introduced into the demineralization chambers. Both of anions and cations in the waste water are moved to the concentration chambers and concentrated in the concentration chambers. Thus, the conventional electrodialysis apparatus cannot selectively remove or concentrate only a desired substance. Further, because a liquid containing an electrolyte is used as an electrode liquid in the conventional electrodialysis apparatus, cations or anions resulting from the electrolyte in the electrode liquid may problematically be mixed into and concentrated in waste water or concentrated water. Furthermore, concentrations of ions in an electrode liquid should be managed and adjusted in order to properly maintain an operation voltage. Thus, troublesome management is required to operate the apparatus.

As described above, there has been desired an apparatus capable of selectively separating cations or anions from waste water containing cations or anions having wide-ranging concentrations from a high concentration to a low concentration and of recovering the cations or anions without contamination of impurities.

### DISCLOSURE OF INVENTION

The present invention has been made in view of the above drawbacks. It is, therefore, a first object of the present invention to provide a liquid treatment apparatus capable of treating not only a liquid containing cations or anions at a high concentration but also a liquid containing cations or anions at a low concentration, capable of preventing contamination or concentration of impurities resulting from a liquid other than raw water, and capable of removing and recovering cations or anions without troublesome processes such as concentration adjustment of a chemical liquid used as an electrode liquid.

A second object of the present invention is to provide a fluorine treatment apparatus for effectively treating fluorine using the above electrodialysis apparatus.

The inventors have diligently studied the above drawbacks and their solutions. As a result, the inventors have found that an ion exchanger combined with electrodialysis can enable a liquid treatment apparatus to effectively remove and recover anions or cations from waste water without troublesome processes such as adjustment of concentrations of chemicals used as electrode liquids or concentration of impurities resulting from liquid other than raw water.

Specifically, according to one aspect of the present invention, there is provided a liquid treatment apparatus employing an ion exchanger combined with electrodialysis. The liquid treatment apparatus has a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove cations (positive ions) or anions (negative ions) from a water to be treated and receive ions having the same charge as the removed ions from the anode chamber or the cathode chamber. The neutralization chamber is configured to receive the removed ions and electrically neutralize the removed ions by ions supplied from the cathode chamber or the anode chamber. The liquid treatment apparatus includes an ion exchange membrane to partition the deionization chamber and the neutralization chamber, and an ion exchanger disposed in at least one of the cathode chamber and the anode chamber.

According to another aspect of the present invention, there is provided a liquid treatment apparatus including a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove anions or cations from a water to be treated and receive ions having the same charge as the selectively removed ions from the cathode chamber or the anode chamber. The neutralization chamber is configured to receive the removed ions and electrically neutralize the ions having the same charge as the ions supplied from the anode chamber or the cathode chamber. An ion exchange membrane is provided to partition the deionization chamber and the neutralization chamber. An ion exchanger is disposed in at least one of the cathode chamber and the anode chamber.

According to another aspect of the present invention, there is provided a liquid treatment apparatus including a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove anions or cations from a water to be treated and receive ions having the same charge as the selectively removed ions from the cathode chamber or the anode chamber. The neutralization chamber is configured to receive the removed ions and electrically neutralize the removed ions by ions supplied from the anode chamber or the cathode chamber. An ion exchange membrane is provided to partition the deionization chamber and the neutralization chamber. At least one of the anode chamber and the cathode chamber is supplied with pure water.

According to another aspect of the present invention, there is provided a liquid treatment apparatus including a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove anions or cations from a water to be treated and receive ions having the same charge as the selectively removed ions from the cathode chamber or the anode chamber. The neutralization chamber is configured to receive the removed ions and electrically neutralize the ions having the same charge as the ions supplied from the anode chamber or the cathode chamber. An ion exchange membrane is provided to partition the deionization chamber and the neutralization chamber. At least one of the anode chamber and the cathode chamber is supplied with pure water.

According to another aspect of the present invention, there is provided a liquid treatment apparatus including a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove anions or cations from a water to be treated and receive ions having the same charge as the selectively removed ions from the cathode chamber or the anode chamber. The neutralization chamber is configured to receive the removed ions and electrically neutralize the removed ions by ions supplied from the anode chamber or the cathode chamber. An ion exchange membrane is provided to partition the deionization chamber and the neutralization chamber. At least one of the anode chamber and the cathode chamber is supplied with a non-electrolyte solution.

According to another aspect of the present invention, there is provided a liquid treatment apparatus including a cathode chamber having a cathode disposed therein, an anode chamber having an anode disposed therein, a deionization chamber disposed between the cathode chamber and the anode chamber, and a neutralization chamber disposed between the cathode chamber and the anode chamber. The deionization chamber is configured to selectively remove anions or cations from a water to be treated and receive ions having the same charge as the selectively removed ions from the cathode chamber or the anode chamber. The neutralization chamber is configured to receive the removed ions and electrically neutralize the ions having the same charge as the ions supplied from the anode chamber or the cathode chamber. An ion exchange membrane is provided to partition the deionization chamber and the neutralization chamber. At least one of the anode chamber and the cathode chamber is supplied with a non-electrolyte solution.

The liquid treatment apparatus may further include an ion exchanger disposed in at least one of the deionization chamber and the neutralization chamber.

At least one of the anode chamber and the cathode chamber may be supplied with pure water.

At least one of the anode chamber and the cathode chamber may be supplied with a non-electrolyte solution.

With the liquid treatment apparatus according to the present invention, anions or cations can be removed or recovered not only from waste water containing anions or cations at a high concentration but also from waste water containing anions or cations at a low concentration. Further, it is possible to prevent contamination or concentration of impurities resulting from liquid other than raw water. Furthermore, it is possible to eliminate troublesome processes such as adjustment of concentrations of chemicals used as electrode liquids. Accordingly, recovery or reuse of treated water or concentrated water is facilitated. Thus, the present invention is remarkably effective in both of environmental protection and resources saving.

According to another aspect of the present invention, there is provided a fluorine treatment system including the above liquid treatment apparatus, and a fluorine recycling apparatus for recovering fluorine-concentrated water as calcium fluoride, the fluorine-concentrated water being obtained from the liquid treatment apparatus.

According to another aspect of the present invention, there is provided a fluorine treatment system including the above liquid treatment apparatus, and a coagulation-sedimentation apparatus for performing coagulation-sedimentation treatment on water containing at least part of fluorine-concentrated water obtained from the liquid treatment apparatus.

According to another aspect of the present invention, there is provided a water recycling system including the above liquid treatment apparatus, and a pure water production apparatus for producing pure water from treated water obtained from the liquid treatment apparatus.

According to another aspect of the present invention, there is provided a water recycling system including the above liquid treatment apparatus, a decomposition apparatus, a passage configured to supply waste water from the decomposition apparatus to the liquid treatment apparatus, and a passage configured to supply part of treated water obtained from the liquid treatment apparatus to the decomposition apparatus.

According to another aspect of the present invention, there is provided a fluorine treatment system including the above liquid treatment apparatus, a solid-liquid separation device for separating a solid substance from waste water containing at least fluorine, and a passage configured to supply the separated waste water from the solid-liquid separation device to the liquid treatment apparatus.

According to another aspect of the present invention, there is provided a fluorine treatment system including the above liquid treatment apparatus, an organic substance separation device for separating an organic substance from waste water containing at least fluorine, and a passage configured to supply the separated waste water from the organic substance separation device to the liquid treatment apparatus.

### BRIEF DESCRIPTION OF DRAWINGS

FIG. 1 is a schematic view showing a liquid treatment apparatus according to an embodiment of the present invention;

FIG. 2 is a schematic view showing a liquid treatment apparatus according to another embodiment of the present invention;

FIG. 3 is a schematic view showing a liquid treatment apparatus according to another embodiment of the present invention;

FIG. 4 is a schematic view showing a liquid treatment apparatus according to another embodiment of the present invention;

FIG. 5 is a schematic view showing a liquid treatment apparatus according to another embodiment of the present invention;

FIG. 6 is a schematic view showing a liquid treatment apparatus according to another embodiment of the present invention;

FIG. 7 is a schematic view showing an example of a fluorine treatment system incorporating the liquid treatment apparatus and a fluorine recycling apparatus according to the present invention;

FIG. 8 is a schematic view showing an example of a fluorine treatment system incorporating the liquid treatment apparatus and a CaF₂ substitution apparatus according to the present invention;

FIG. 9 is a schematic view showing an example of a fluorine treatment system incorporating the liquid treatment apparatus and a CaF₂ crystallizing apparatus according to the present invention;

FIG. 10 is a schematic view showing an example of a fluorine treatment system incorporating the liquid treatment apparatus and a coagulation-sedimentation apparatus according to the present invention;

FIG. 11 is a schematic view showing an example of a fluorine treatment system incorporating the liquid treatment apparatus and a decomposition apparatus according to the present invention;

FIG. 12 is a schematic view showing an example of a fluorine treatment system incorporating the liquid treatment apparatus and an activated carbon absorption layer according to the present invention; and

FIG. 13 is a schematic view showing an example of a fluorine treatment system incorporating the liquid treatment apparatus and a vacuum distillation apparatus according to the present invention.

### BEST MODE FOR CARRYING OUT THE INVENTION

A liquid treatment apparatus according to embodiments of the present invention will be described below with reference to the drawings.

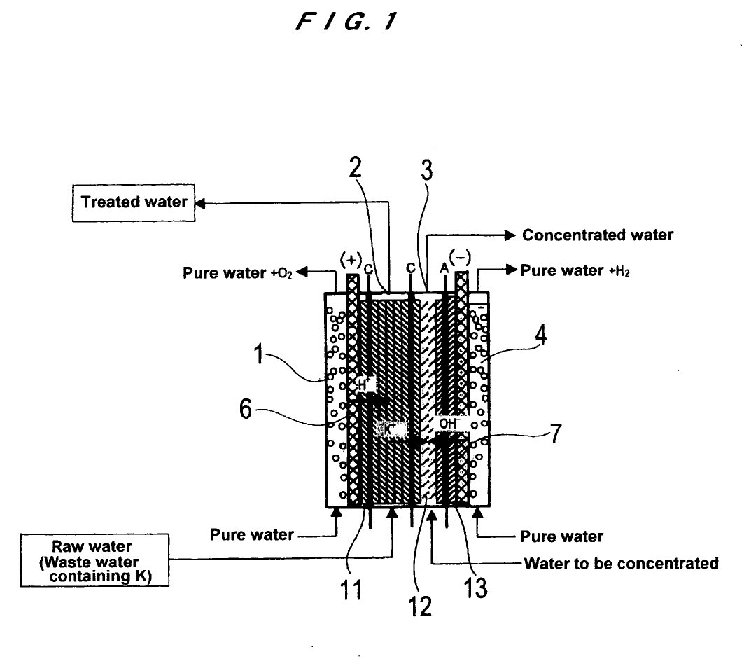

FIG. 1 is a treatment flow diagram showing an example of a liquid treatment apparatus according to an embodiment of the present invention. Specifically, FIG. 1 shows an example of selectively separating cations from raw water (a liquid to be treated) and concentrating cations so as to produce treated water, which has a lowered concentration of the cations, and concentrated water, which has an increased concentration of the cations. As shown in FIG. 1, the liquid treatment apparatus has four chambers including an anode chamber 1, a deionization chamber 2, a neutralization chamber 3, and a cathode chamber 4.

The anode chamber 1 includes an anode 6 disposed therein. The cathode chamber 4 includes a cathode 7 disposed therein. The deionization chamber 2 serves to selectively remove only cations from raw water and discharge treated water, which has a lowered concentration of the cations. The neutralization chamber 3 serves to receive the cations from the deionization chamber 2 and electrically neutralize the cations by hydroxide ions supplied from the cathode chamber 4.

The anode chamber 1 and the deionization chamber 2 are partitioned by a cation exchange membrane C. The deionization chamber 2 and the neutralization chamber 3 are partitioned by a cation exchange membrane C. The neutralization chamber 3 and the cathode chamber 4 are partitioned by an anion exchange membrane A. The raw water is supplied into the deionization chamber 2, which is disposed between the cation exchange membranes C and C, and cations in the raw water are captured by a cation exchanger provided within the deionization chamber 2.

The liquid treatment apparatus includes a power source (not shown) for applying a DC voltage between the anode 6 and the cathode 7. Hydrogen ions are produced in the anode chamber 1 by electrolysis and moved toward the cathode 7. The cations captured by the cation exchanger in the deionization chamber 2 are moved through the cation exchange membrane C into the neutralization chamber 3. Hydroxide ions are produced in the cathode chamber 4 by electrolysis and moved toward the anode 6. Thus, the hydroxide ions are moved through the anion exchange membrane A into the neutralization chamber 3. As a result, a liquid in which the cations are concentrated is produced in the neutralization chamber 3. In this case, an operation voltage of the power source can be maintained at a low value ranging from 5 V to 30 V even if the concentration of the cations in the raw water is not more than several hundreds of milligrams per liter.

The operation voltage can be reduced because of the following arrangement. All elements located between a surface of the anode 6 in the anode chamber 1 and an inner wall of the neutralization chamber 3 are formed by continuous cation exchangers including the non-woven cation exchange fabric 11, the cation exchange spacer 12, and the cation exchange membranes C. Accordingly, hydrogen ions produced on the anode can reach the neutralization chamber 3 so that the hydrogen ion conduction is hardly influenced by the concentration of the cations in the raw water. When cations are present in the deionization chamber 2, hydrogen ions are exchanged for cations in the raw water by ion exchange reaction, so that the cations in the raw water reach the neutralization chamber 3 in place of the hydrogen ions.

The operation voltage can also be reduced because of the following arrangement. All elements located between a surface of the cathode 7 in the cathode chamber 4 and an inner wall of the neutralization chamber 3 are formed by continuous anion exchangers including the non-woven anion exchange fabric 13 and the anion exchange membrane A. Accordingly, hydroxide ions produced in the cathode chamber 4 can reach the neutralization chamber 3 through surfaces and interiors of the anion exchangers by ionic conduction.

The arrangement of the ion exchangers in the neutralization chamber 3 is such that the non-woven cation exchange fabric 11, the cation exchange spacer 12, and the non-woven anion exchange fabric 13 are arranged in this order from the anode side. Another type of ion exchanger, such as an anion exchange spacer 14, may be provided between the non-woven cation exchange fabric 11 and the non-woven anion exchange fabric 13.

As described above, the cathode chamber 4 and the anode chamber 1 have an anion exchanger and a cation exchanger, which are brought into contact with the electrodes and the ion exchange membranes, respectively. Accordingly, a voltage between the anode 6 and the cathode 7 is not influenced by the concentration of ions in an electrode liquid. It is desirable to use pure water as an electrode liquid. As a result, since cations in the anode chamber 1 include only hydrogen ions, no cations other than cations in the raw water can be mixed into and stored in the treated water or the concentrated water. Further, since anions in the cathode chamber 4 include only hydroxide ions, no anions other than anions in the raw water can be mixed into and stored in the concentrated water.

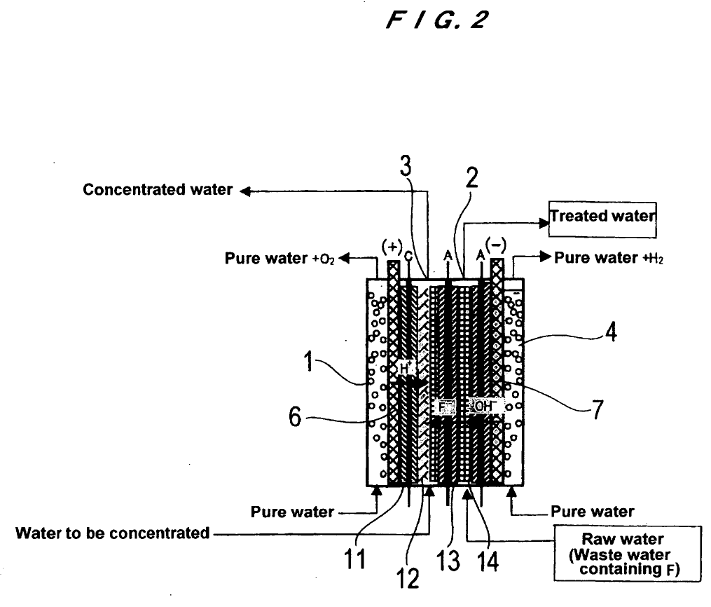

FIG. 2 is a treatment flow diagram showing another example of a liquid treatment apparatus according to the present invention. Specifically, FIG. 2 shows an example of selectively separating anions from raw water (a liquid to be treated) and concentrating anions so as to produce treated water, which has a lowered concentration of the anions, and concentrated water, which has an increased concentration of the anions. In the previously described liquid treatment apparatus, the deionization chamber 2 is disposed adjacent to the anode chamber 1, as shown in FIG. 1. In FIG. 2, a deionization chamber 2 is disposed adjacent to a cathode chamber 4, and a neutralization chamber 3 is disposed adjacent to an anode chamber 1.

The anode chamber 1 and the neutralization chamber 3 are partitioned by a cation exchange membrane C. The neutralization chamber 3 and the deionization chamber 2 are partitioned by an anion exchange membrane A. The deionization chamber 2 and the cathode chamber 4 are partitioned by an anion exchange membrane A. The deionization chamber 2 serves to selectively remove only anions from raw water and discharge treated water, which has a lowered concentration of the anions. The neutralization chamber 3 serves to receive the anions from the deionization chamber 2 and electrically neutralize the anions by hydrogen ions supplied from the anode chamber 1. The raw water is supplied into the deionization chamber 2, which is disposed between the anion exchange membranes A and A, and anions in the raw water are captured by an anion exchanger provided within the deionization chamber 2.

The liquid treatment apparatus includes a power source (not shown) for applying a DC voltage between the anode 6 and the cathode 7. Hydroxide ions are produced in the cathode chamber 4 by electrolysis and moved toward the anode 6. The anions captured by the anion exchanger in the deionization chamber 2 are moved through the anion exchange membrane A into the neutralization chamber 3. Hydrogen ions are produced in the anode chamber 1 by electrolysis and moved toward the cathode 7. Thus, the hydrogen ions are moved through the cation exchange membrane C into the neutralization chamber 3. As a result, a liquid in which the anions are concentrated is produced in the neutralization chamber 3. In this case, an operation voltage of the power source can be maintained at a low value ranging from 5 V to 30 V even if the concentration of the anions in the raw water is not more than several hundreds of milligrams per liter.

The operation voltage can be reduced because of the following arrangement. All elements located between a surface of the cathode 7 in the cathode chamber 4 and an inner wall of the neutralization chamber 3 are formed by continuous anion exchangers including the non-woven anion exchange fabric 13, the anion exchange spacer 14, and the anion exchange membranes A. Accordingly, hydroxide ions produced on the cathode 7 can reach the neutralization chamber 3 so that the hydroxide ion conduction is hardly influenced by the concentration of the anions in the raw water. When anions are present in the deionization chamber 2, hydroxide ions are exchanged for anions in the raw water by ion exchange reaction, so that the anions in the raw water reach the neutralization chamber 3 in place of the hydroxide ions.

The operation voltage can also be reduced because of the following arrangement. All elements located between a surface of the anode 6 in the anode chamber 1 and the neutralization chamber 3 are formed by continuous cation exchangers including the non-woven cation exchange fabric 11, the cation exchange spacer 12, and the cation exchange membrane C. Accordingly, hydrogen ions produced in the anode chamber 1 can reach the neutralization chamber 3 through surfaces and interiors of the cation exchangers by ionic conduction.

When anions are to be concentrated, it is desirable to use pure water as an electrode liquid. Since cations in the anode chamber 1 include only hydrogen ions, no cations other than cations in the raw water can be mixed into and stored in the treated water or the concentrated water. Further, since anions in the cathode chamber 4 include only hydroxide ions, no anions other than anions in the raw water can be mixed into and stored in the treated water or the concentrated water.

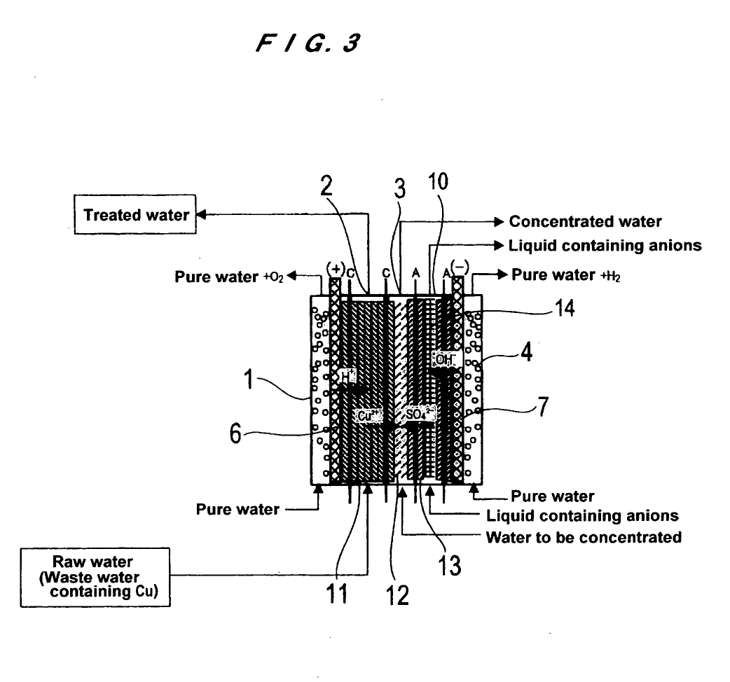

FIG. 3 is a schematic view showing another example of a liquid treatment apparatus according to the present invention. The liquid treatment apparatus shown in FIG. 3 has an anion supply chamber 10 partitioned by anion exchange membranes A and A between a cathode chamber 4 and a neutralization chamber 3.

When cations of metal ions are to be concentrated, a high concentration of hydroxide ions may exert an adverse influence on operation of an electrodialysis apparatus.

For example, when metal hydroxide is deposited, a liquid containing anions (e.g., sulfate ions) other than hydroxide ions may be supplied into the anion supply chamber 10 partitioned by anion exchange membranes A and A between the cathode chamber 4 and the neutralization chamber 3. Thus, anions other than hydroxide ions can be introduced into the neutralization chamber 3 so as to prevent formation of metal hydroxide.

For example, when copper is to be separated and concentrated, a sulfuric acid solution is supplied into the anion supply chamber 10 provided between the cathode chamber 4 and the neutralization chamber 3. In this case, OH⁻ ions produced in the cathode chamber 4 are prevented from directly flowing into the neutralization chamber 3. Accordingly, it is possible to prevent deposition of Cu(OH)₂ in the neutralization chamber 3. Thus, the ion exchanger and the ion exchange membrane are prevented from being covered with Cu(OH)₂ so as to deteriorate ion exchange functions.

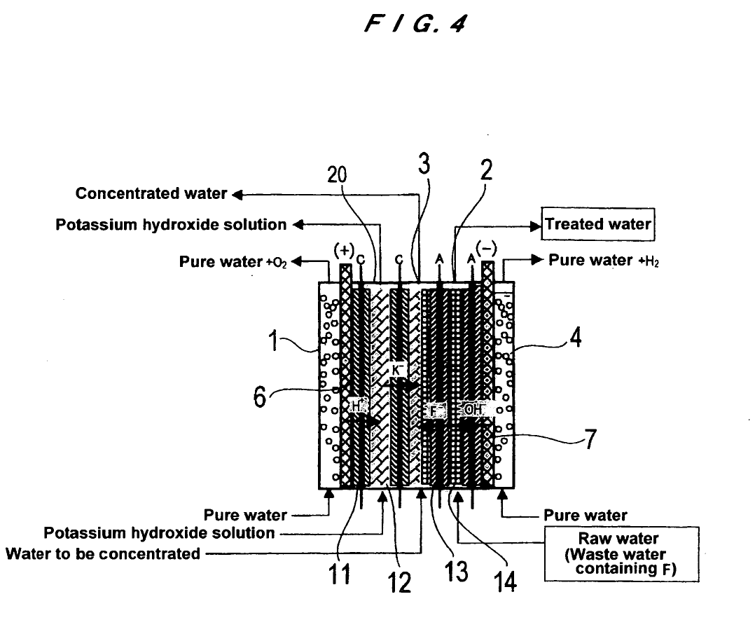

FIG. 4 is a treatment flow diagram showing another example of a liquid treatment apparatus according to the present invention. The liquid treatment apparatus shown in FIG. 4 has a cation supply chamber 20 partitioned by cation exchange membranes C and C between an anode chamber 1 and a neutralization chamber 3.

When anions are to be concentrated as a salt, a liquid containing cations (e.g., sodium ions) other than hydrogen ions is supplied into the cation supply chamber 20, partitioned by cation exchange membranes C and C, provided between the anode chamber 1 and the neutralization chamber 3. Thus, cations other than hydrogen ions can be introduced into the neutralization chamber 3 so that anions which have been removed from raw water can be concentrated as a salt.

As described above, according to the present invention, an influence on an operation voltage from concentrations of cations or anions in raw water and from water quality in the anode or cathode chamber can substantially be eliminated. An operation voltage can be maintained at a low value even if the concentration of cations or anions in the raw water is not more than several hundreds of milligrams per liter.

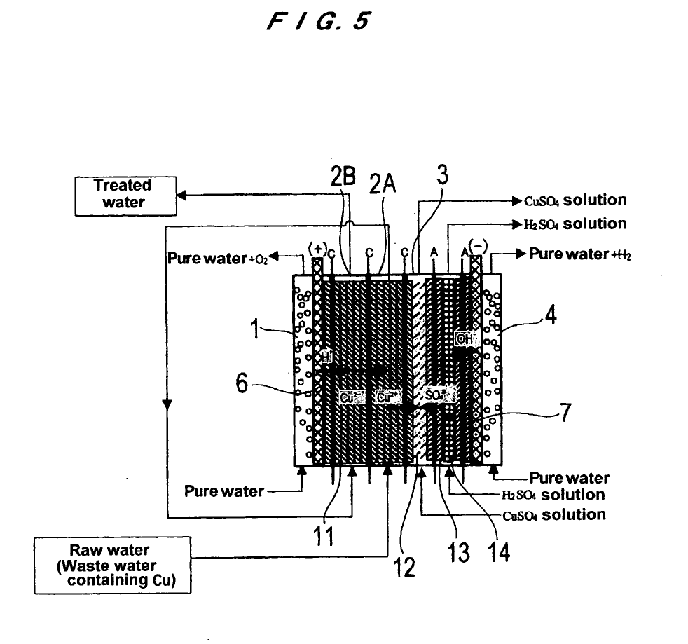

FIG. 5 is a treatment flow diagram showing another example of a liquid treatment apparatus according to the present invention. The liquid treatment apparatus shown in FIG. 5 has two deionization chambers 2A and 2B disposed adjacent to each other and coupled in series.

In order to enhance capability of separating cations or anions, two or more deionization chambers through which the raw water passes may be disposed adjacent to each other so that the raw water is supplied to the deionization chambers in series. With this arrangement, cations or anions leaking out of the preceding deionization chamber 2A can be captured and removed in the subsequent deionization chamber 2B. Finally, the cations or anions are moved to a neutralization chamber 3 through the preceding deionization chamber 2A by potential gradient. Accordingly, it is possible to produce treated water from which cations or anions have been removed to a high degree.

In order to increase the amount of treated water, the liquid treatment apparatus may have a bipolar electrode structure. In this case, it is desirable to fill an electrode and an ion exchanger in a bipolar electrode chamber.

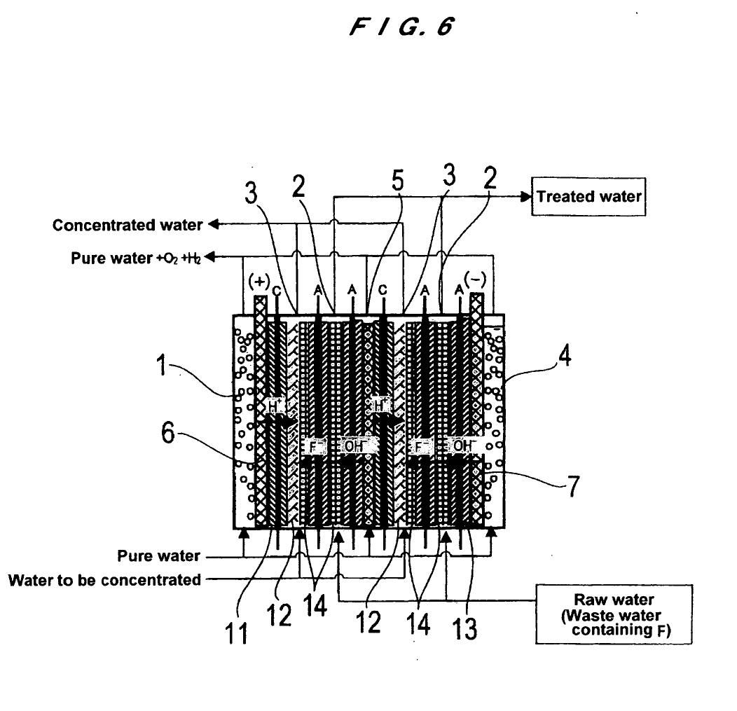

FIG. 6 is a schematic view showing an example of a liquid treatment apparatus according to the present invention. The liquid treatment apparatus has a bipolar electrode structure to increase the amount of treated water. As shown in FIG. 6, the liquid treatment apparatus has a bipolar electrode chamber 5 disposed at a central portion of the liquid treatment apparatus. A neutralization chamber 3 and a deionization chamber 2 are provided between the bipolar electrode chamber 5 and an anode chamber 1. A neutralization chamber 3 and a deionization chamber 2 are provided between the bipolar electrode chamber 5 and a cathode chamber 4.

The anode chamber 1 and the neutralization chamber 3 are partitioned by a cation exchange membrane C. The neutralization chamber 3 and the deionization chamber 2 are partitioned by an anion exchange membrane A. The deionization chamber 2 and the bipolar electrode chamber 5 are partitioned by an anion exchange membrane A. Further, the cathode chamber 4 and the deionization chamber 2 are partitioned by an anion exchange membrane A. The deionization chamber 2 and the neutralization chamber 3 are partitioned by an anion exchange membrane A. The neutralization chamber 3 and the bipolar electrode chamber 5 are partitioned by a cation exchange membrane C. The bipolar electrode chamber 5 serves to supply hydroxide ions to the deionization chamber 2 and to supply hydrogen ions to the neutralization chamber 3.

Thus, since the liquid treatment apparatus has a bipolar electrode structure, it is possible to increase the amount of treated water.

In the above embodiments, it is desirable to operate the liquid treatment apparatus with a constant current or a low voltage. It is desirable that the current density is not more than 3 A/dm². At that time, the voltage may be at most 30 V. Each of the deionization chamber and the neutralization chamber may have a thickness of 1 to 10 mm, preferably 2 to 4 mm.

The electrodes (anode, cathode, and bipolar electrode) may be made of platinum, tantalum, niobium, diamond, SUS, or the like. The electrodes may be in the form of a flat plate or a mesh lath (expanded metal) having water permeability and gas permeability. The concentration of the concentrated water is not limited to a specific range. However, the concentrated water preferably has a cation concentration or an anion concentration of 100 to 100000 mg/l. Further, the concentration of the raw water is not limited to a specific range. However, the raw water preferably has a cation concentration or an anion concentration of 10 to 500 mg/l. In this case, the concentration of the treated water can be adjusted to a desired value by adjusting operational conditions such as a current value. The treated water has a cation concentration or an anion concentration of 0.01 to 10 mg/l.

It is desirable to supply pure water to the anode chamber 1, the cathode chamber 4, and the bipolar electrode chamber 5. Pure water to be supplied is not limited to a specific type of pure water. All types of pure water that is generated by various pure water generation methods, which have been employed by one ordinarily skilled in the art, can be used in the liquid treatment apparatus. For example, known methods including a reverse osmosis (RO) membrane method, an ion exchange method, a distillation method, or an electric desalting method, or a combination thereof can be used to generate pure water. Alternatively, ultrapure water, which is generated by further purifying pure water, may be supplied to the anode chamber, the cathode chamber, and the bipolar electrode chamber. Further, a non-electrolyte solution can be used instead of pure water. For example, isopropyl alcohol may be added as a non-electrolyte into pure water at a concentration of about 0.5 mg/l to generate a non-electrolyte solution. Such a non-electrolyte solution can be used without hindrance.

The ion exchangers used in the deionization chamber 2, the neutralization chamber 3, the anode chamber 1, the cathode chamber 4, and the bipolar electrode chamber may comprise a fibrous material including a base of polymer fibers to which an ion exchange group is introduced by graft polymerization. The base of polymer fibers to be grafted may be formed by single fibers of polyolefin such as polyethylene or polypropylene, or composite fibers having a core portion and a sheath portion which are made of different polymers.

For example, such composite fibers may have a sheath-core structure including a sheath made of polyolefin such as polyethylene and a core made of other polymer such as polypropylene. When an ion exchange group is introduced into such composite fibers by radiation-induced graft polymerization, a resultant fibrous material is suitable for a material for the aforementioned ion exchangers because it has an excellent ion exchange capacity and a uniform thickness. The fibrous ion exchange material may be in the form of a woven fabric, a non-woven fabric, or the like.

Further, the ion exchangers used as a spacer in the form of a diagonal net or the like may comprise polyolefin resin. For example, such polyolefin resin is produced by providing an ion exchange function to a polyethylene diagonal net, which is widely employed in electrodialysis baths, by using radiation-induced graft polymerization. The resultant polyolefin resin has an excellent ion exchange capacity and an excellent function to disperse water.

Radiation-induced graft polymerization comprises irradiating a polymer base with a radiation ray to produce a radical, and allowing the radical to react with a monomer to introduce the monomer into the polymer base.

Radiation rays for radiation-induced graft polymerization include α-rays, β-rays, γ-rays, electron beams, ultraviolet rays, and the like. Particularly, γ-rays or electron beams are preferably used for the purposes of the present invention. Radiation-induced graft polymerization includes some types of methods such as pre-irradiation graft polymerization and co-irradiation graft polymerization. Pre-irradiation graft polymerization comprises previously irradiating a graft base with a radiation ray and then brining the base into contact with a grafting monomer. Co-irradiation graft polymerization comprises irradiating a base and a monomer with a radiation ray at the same time. Both methods can be employed for the purposes of the present invention.

Further, depending upon a manner of contact between a monomer and a base, polymerization methods are classified into a liquid-phase graft polymerization method, which comprises performing polymerization while a base is immersed in a monomer solution, a gas-phase graft polymerization method, which comprises performing polymerization while a base is brought into contact with vapor of a monomer, and an immersion gas-phase graft polymerization method, which comprises first immersing a base in a monomer solution, taking the base out of the monomer solution, and performing polymerization in a gas phase. These methods can be applicable to the present invention.

Ion exchange groups to be introduced into fibrous bases such as a nonwoven fabric or spacer bases are not limited to a specific type of ion exchange groups. Various kinds of cation exchange groups and anion exchange groups can be used. For example, cation exchange groups include strongly acidic cation exchange groups such as sulfo group, moderately acidic cation exchange groups such as phosphoric group, and weakly acidic cation exchange groups such as carboxyl group. Anion exchange groups include weakly basic anion exchange groups such as primary, secondary, and tertiary amino groups, and strongly basic anion exchange groups such as quaternary ammonium group. Further, an ion exchanger having both of the aforementioned cation and anion groups may also be employed.

The ion exchangers may have a functional group derived from iminodiacetic acid or its sodium salt, a functional group derived from various amino acids including phenylalanine, lysine, leucine, valine, proline or their sodium salts, or a functional group derived from iminodiethanol.

Monomers having an ion exchange group may include acrylic acid (AAc), methacrylic acid, sodium styrenesulfonate (SSS), sodium methallylsulfonate, sodium allylsulfonate, sodium vinylsulfonate, vinylbenzyl trimethylammonium chloride (VBTAC), diethylaminoethyl methacrylate, and dimethylaminopropylacrylamide. For example, while sodium styrenesulfonate is used as a monomer, radiation-induced graft polymerization is performed to introduce sulfo group of a strongly acidic cation exchange group directly into a base. Further, while vinylbenzyl trimethylammonium chloride is used as a monomer, radiation-induced graft polymerization is performed to introduce quaternary ammonium group of a strongly basic anion exchange group directly into a base.

The monomer having groups that can be converted into ion exchange groups may include acrylonitrile, acrolein, vinylpyridine, styrene, chloromethylstyrene, and glycidyl methacrylate (GMA). For example, glycidyl methacrylate is introduced into a base by radiation-induced graft polymerization so as to react with a sulfonating agent such as sodium sulfite. Thus, sulfo group of a strongly acidic cation exchange group can be introduced into the base. Alternatively, graft polymerization is performed on a base with chloromethylstyrene, and then the base is immersed in an aqueous solution of trimethylamine to perform quaternary-ammonification. Thus, quaternary ammonium group of a strongly basic anion exchange group can be introduced into the base.

Further, graft polymerization is performed on a base with chloromethylstyrene, and the base reacts with a sulfide to produce a sulfonium salt. Then, the sulfonium salt reacts with sodium iminodiacetate. Thus, sodium iminodiacetate group of a functional group can be introduced into the base. Alternatively, graft polymerization is performed on a base with chloromethylstyrene, and chloro group is substituted with iodine group. Then, the iodine group reacts with an iminodiacetic acid diethyl ester to substitute the iodine group with an iminodiacetic acid diethyl ester group. Thereafter, the ester group reacts with sodium hydroxide to convert the ester group into sodium salt. Thus, sodium iminodiacetate of a functional group can be introduced into the base.

Among the aforementioned various types of ion exchangers, an ion exchange fibrous material in the form of a non-woven fabric or a woven fabric is particularly preferable. Fibrous materials such as a woven fabric or a non-woven fabric have surface areas considerably larger than those of materials in the form of beads or a diagonal net. Accordingly, a larger amount of ion exchange groups can be introduced into the fibrous materials. Further, unlike resin beads in which ion exchange groups are present in micropores or macropores within the beads, such fibrous materials can have all the ion exchange groups on surfaces of fibers. Accordingly, metal ions in water to be treated can readily be diffused into the vicinity of ion exchange groups. Thus, the ions are adsorbed by ion exchange. Therefore, the use of a fibrous ion exchange material can improve removal and recovery efficiency of metal ions.

In addition to the aforementioned fibrous ion exchange materials, any ion exchange resin beads known in the art may be used for an ion exchange material. For example, beads including polystyrene which is crosslinked with divinylbenzene are used as a base resin and sulfonated by a sulfonating agent such as sulfuric acid or chlorosulfonic acid. Thus, sulfo group is introduced into the base resin to produce strongly acidic cation exchange resin beads.

This production method has been known in the art. A variety of products produced by this method are now commercially available. Further, the resin beads may have a functional group derived from iminodiacetic acid and its sodium salt, a functional group derived from various amino acids such as phenylalanine, lysine, leucine, valine, praline, and their sodium salts, and a functional group derived from iminodiethanol.

Next, specific embodiments will be described.

FIG. 1 shows an example of concentrating cations. In the anode chamber 1, the non-woven cation exchange fabric 11 is interposed between the electrode in the form of a mesh lath (an expanded metal) and the cation exchange membrane C. The deionization chamber 2 is filled with the non-woven cation exchange fabric 11. The neutralization chamber 3 is filled with the non-woven cation exchange fabric 11, the cation exchange spacer 12, and the non-woven anion exchange fabric 13 in this order from the anode side. A cation exchanger or an anion exchanger, other than the cation exchange spacer 12, may be interposed between the non-woven cation exchange fabric 11 and the non-woven cation exchange fabric 11. In the cathode chamber 4, the non-woven anion exchange fabric 13 is interposed between the electrode in the form of a mesh lath (an expanded metal) and the anion exchange membrane A.

Because the mesh-lath electrodes are used in the anode chamber 1 and the cathode chamber 4, a hydrogen gas or an oxygen gas, resulting from electrode reaction, is delivered through holes in the electrodes to the back side thereof. Therefore, the gas, which is an insulating substance, does not remain in the non-woven cation exchange fabric 11 or the non-woven anion exchange fabric 13. As a result, electrical resistance can be prevented from increasing.

FIG. 2 shows an example of concentrating anions. In the anode chamber 1, the non-woven cation exchange fabric 11 is interposed between the electrode in the form of a mesh lath (an expanded metal) and the cation exchange membrane C. The neutralization chamber 3 is filled with the non-woven cation exchange fabric 11, the cation exchange spacer 12, the anion exchange spacer 14, and the non-woven anion exchange fabric 13 in this order from the anode side. Any type of cation exchanger or anion exchanger can be interposed between the non-woven cation exchange fabric 11 and the non-woven cation exchange fabric 11. The deionization chamber 2 is filled with the non-woven anion exchange fabric 13 and the anion exchange spacer 14. Each of the cathode chamber 4 and the anode chamber 1 has the same structure as that shown in FIG. 1.

FIG. 3 shows an example of concentrating cations as a form other than hydroxide. More specifically, FIG. 3 shows an example of concentrating copper in the raw water as copper sulfate. The anion supply chamber 10 is arranged between the cathode chamber 4 and the neutralization chamber 3, and is partitioned by the anion exchange membranes A and A. Water containing sulfate ions flows through this anion supply chamber 10. The anion supply chamber 10 is filled with the anion exchange spacer 14 in this example. Alternatively, another type of anion exchanger or a spacer having no ion-exchange function may be used to fill the chamber 10. With this arrangement, sulfate ions, instead of hydroxide ions, can be supplied into the neutralization chamber 3.

FIG. 4 shows an example of concentrating anions as a form other than acid. More specifically, FIG. 4 shows an example of concentrating fluorine in the raw water as potassium fluoride. The cation supply chamber 20 is arranged between the anode chamber 1 and the neutralization chamber 3, and is partitioned by the cation exchange membranes C and C. Water containing potassium ions flows through this cation supply chamber 20. The cation supply chamber 20 is filled with the cation exchange spacer 12 in this example. Alternatively, another type of cation exchanger or a spacer having no ion-exchange function may be used to fill the chamber 20. With this arrangement, potassium ions, instead of hydrogen ions, can be supplied into the neutralization chamber 3.

FIG. 5 shows an example of further lowering the cation concentration of the treated water. Two or more deionization chambers may be disposed adjacent to each other so that the raw water flows through these deionization chambers successively. With this arrangement, cations leaking out of the preceding deionization chamber can be captured and removed in the subsequent deionization chamber. Finally, the cations are moved to the neutralization chamber 3 through the preceding deionization chamber by potential gradient. Similarly, in the case of further lowering the anion concentration of the treated water, two or more deionization chambers can be disposed adjacent to each other so that the raw water flows through these deionization chambers successively. In this case also, the same effect as that in the case of lowering cations can be obtained.

FIG. 6 shows an example of increasing the amount of treated water by providing the bipolar electrode structure. The following descriptions are the case of concentrating anions. The bipolar electrode chamber 5 has a structure in which the non-woven anion exchange fabric and the non-woven cation exchange fabric are disposed on both sides of the electrode. The bipolar electrode chamber 5 is supplied with pure water as an electrode liquid.

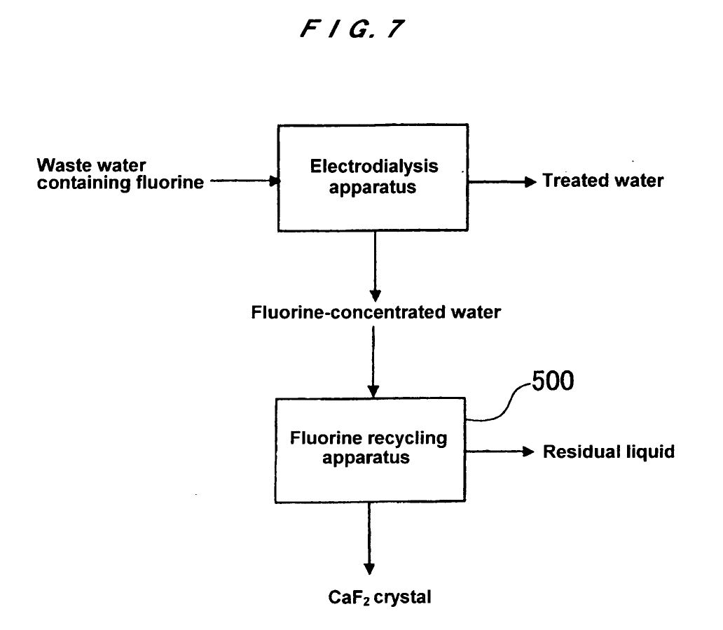

The above-mentioned liquid treatment apparatus can be combined with a fluorine recycling apparatus to constitute a fluorine treatment system. For example, as shown in FIG. 7, waste water containing fluorine is treated by the above-mentioned liquid treatment apparatus (electrodialysis apparatus), and the resulting fluorine-concentrated water, i.e., water having an increased concentration of fluorine, is supplied to a fluorine recycling apparatus 500, where fluorine in the waste water can be recovered as calcium fluoride (CaF₂) crystal.

The above-mentioned liquid treatment apparatus is operated or controlled as follows. First, a fluorine-concentration measuring device is provided for measuring a concentration of fluorine in the treated water or the fluorine-concentrated water obtained from the liquid treatment apparatus, or in the raw water. A conductivity meter for measuring electrical conductivity, a fluorine-concentration meter for measuring a concentration of fluorine using an ion electrode method or the like can be used as the fluorine-concentration measuring device. Providing such a measuring device can allow monitoring of a treatment performance. Further, a flow meter can be provided in a raw-water line and/or a treated water line, so that a fluorine load can be monitored.

It is preferable to provide a fluorine-concentration controlling device for controlling the concentration of fluorine in the treated water. A preferable example of such a fluorine-concentration controlling device is a device operable to automatically adjust an amount of electricity to be supplied to the liquid treatment apparatus based on a monitoring value of the concentration of fluorine in the raw water, the treated water or the concentrated water, the fluorine load, or the treatment performance. Another preferable example of the fluorine-concentration controlling device is a device operable to automatically adjust a flow rate of the raw water using a flow rate adjustment valve based on the above-mentioned monitoring value. With this structure, the concentration of fluorine in the treated water can be automatically controlled. The raw water may be automatically supplied to the ion exchange resin layer only when the concentration of fluorine in the treated water is higher than a predetermined value. In this case, the quality of the treated water can be more stabilized. Further, the fluorine-concentration measuring device may be used to detect that the concentration of the fluorine-concentrated water is decreased to less than a predetermined value or that the concentration of the treated water is increased to a predetermined value. With this structure, it is possible to output an error signal indicating a failure in the electrodialysis apparatus, such as tearing of the ion exchange membrane.

Regardless of types of secondary treatment apparatuses for the fluorine-concentrated water (e.g., a fluorine recycling apparatus, a coagulation-sedimentation apparatus, a vacuum distillation apparatus), the fluorine-concentrated water having a stable concentration of fluorine is supplied to such secondary treatment apparatuses, so that the secondary treatment apparatuses can stably perform secondary treatment on the fluorine-concentrated water. Examples of the above fluorine recycling apparatus include a CaF₂ crystallizing apparatus and a CaF₂ substitution apparatus for recovering fluorine by causing reaction between fluorine and calcium carbonate.

Controlling of the concentration of fluorine in the fluorine-concentrated water is performed as follows. Based on the measurement value of the fluorine-concentration measuring device, such as the conductivity meter or fluorine concentration meter, mounted on the fluorine-concentrated water line, an amount of fluorine-concentrated water to be drawn from the fluorine-concentrated water line or a fluorine-concentrated water tank (i.e., an amount of fluorine-concentrated water to be sent to the secondary treatment apparatus) is adjusted, or an amount of water to be supplied to the fluorine-concentrated water line or the fluorine-concentrated water tank is adjusted. Further, it is possible to automatically adjust an amount of electricity to be supplied or a flow rate of the raw water in the liquid treatment apparatus.

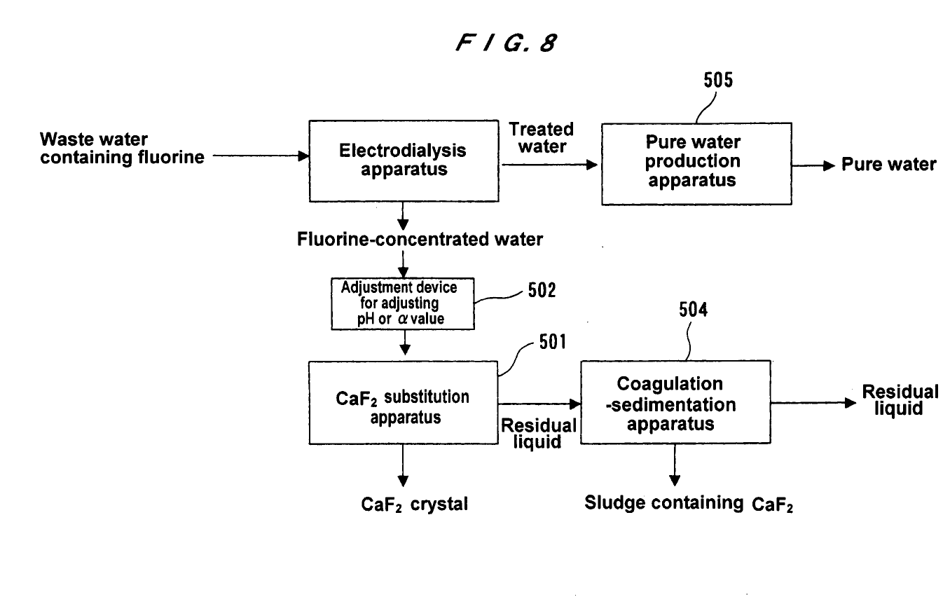

In order to optimize the operational conditions of the secondary treatment apparatus for the fluorine-concentrated water, the following structures can be employed. As shown in FIG. 8, for example, the liquid treatment apparatus according to the present invention is combined with a CaF₂ substitution apparatus 501, serving as a fluorine recycling apparatus, to thereby constitute a fluorine treatment system for recovering fluorine in the waste water as CaF₂ crystal. A measuring device is provided for measuring a pH or a value (a value of acidity) of the fluorine-concentrated water obtained from the above liquid treatment apparatus. Further, an adjustment device 502 is preferably provided for adjusting and optimizing a pH or a value of the waste water by introducing acid or alkali. With these structures, calcium carbonate particles used in the CaF₂ substitution apparatus 501 can be prevented from being dissolved. Further, purity of the CaF₂ crystal can be increased.

Particularly, decomposition waste water (i.e., waste water discharged from a decomposition apparatus, such as harmful substance abatement apparatus) may contain hydrochloric acid, sulfuric acid, nitric acid, or the like, in addition to hydrofluoric acid. These acids, other than hydrofluoric acid, have properties that dissolve calcium carbonate. The liquid treatment apparatus according to the present invention may possibly concentrate these acids together with hydrofluoric acid. Therefore, for example, when treating decomposition waste water as the fluorine-concentrated water, the above-mentioned adjustment device 502 is operated so as to increase the pH or decrease the acidity to thereby prevent dissolution of calcium carbonate. It is preferable to introduce a residual liquid from the CaF₂ substitution apparatus 501 to a coagulation-sedimentation apparatus 504 and to separate and remove fluorine as sludge from the residual liquid in the coagulation-sedimentation apparatus 504.

The liquid treatment apparatus according to the present invention can set operational conditions such that the concentration of fluorine in the treated water is below a wastewater reference value of 8 mg-F/l. Therefore, a further coagulation-sedimentation treatment is not needed for the treated water. Accordingly, it is possible to release or recycle the treated water without establishing a large-scale coagulation-sedimentation treatment facility. For example, as shown in FIG. 8, by introducing the treated water discharged from the liquid treatment apparatus into a pure water production apparatus 505 so as to reuse the treated water as raw water, an amount of water to be used in the facility (purchase cost of water) can be reduced.

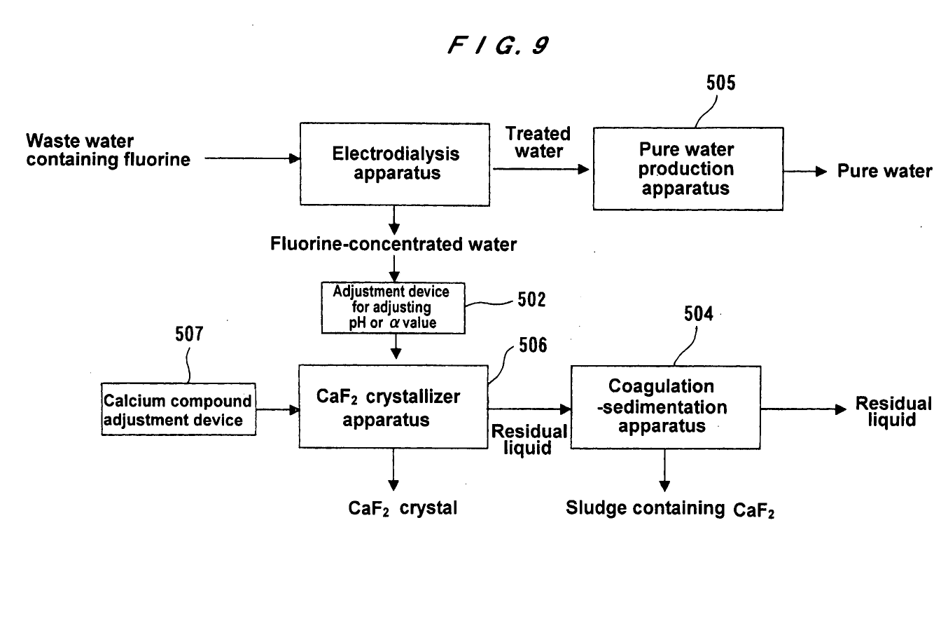

Further, for example, as shown in FIG. 9, the liquid treatment apparatus according to the present invention can be combined with a CaF₂ crystallizing apparatus 506 as a fluorine recycling apparatus to constitute a fluorine treatment system for recovering fluorine in the waste water as CaF₂ crystal. In this case, the adjustment device 502 can adjust the pH or a value (acidity) of the fluorine-concentrated water to a suitable value for crystallization.

Further, a calcium compound adjustment device 507 may be provided for adjusting an amount of calcium compound (e.g., calcium chloride, calcium hydroxide) to be added in the CaF₂ crystallizing apparatus 506, so that an appropriate amount of calcium compound is added in accordance with the measurement value of the fluorine-concentration measuring device for the fluorine-concentrated water. With this structure, even when the concentration of fluorine in the fluorine-concentrated water fluctuates, the amount of calcium compound to be added can be adjusted according to such fluctuation. Therefore, the resulting CaF₂ crystal can have a desired purity and a desired particle size. It is preferable to introduce a residual liquid from the CaF₂ crystallizing apparatus 506 to the coagulation-sedimentation apparatus 504 and to separate and remove fluorine as sludge from the residual liquid in the coagulation-sedimentation apparatus 504.

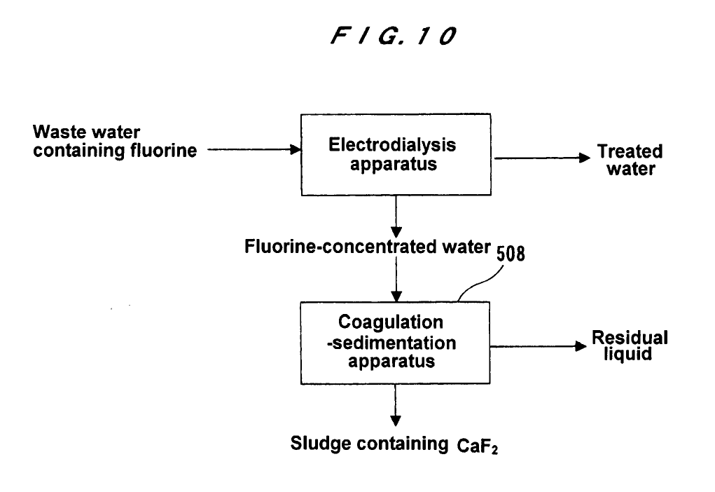

As shown in FIG. 10, the liquid treatment apparatus according to the present invention can be combined with a coagulation-sedimentation treatment apparatus 508 for performing coagulation-sedimentation treatment on water containing at least part of the fluorine-concentrated water, so that fluorine in the fluorine-concentrated water can be separated and removed as sludge containing CaF₂. In this case, even if the concentration of fluorine in the waste water is extremely low and the coagulation-sedimentation treatment cannot properly be performed, the concentration of fluorine can be increased to a level high enough to properly perform the coagulation-sedimentation treatment. Further, because an amount of fluorine-concentrated water is smaller than an amount of the waste water containing fluorine, an amount of coagulating agent to be added (e.g., an amount used per day) can be small, compared with the case of performing the coagulation-sedimentation treatment on the waste water containing fluorine as it is. Further, a small treatment facility can be used to separate solid and liquid from one another. For example, when concentrating fluorine in the waste water ten times, the amount of treated water discharged from the coagulation-sedimentation treatment apparatus 508 can be reduce to one-tenth.

In a case where the waste water containing fluorine further contains solid substances, such as a suspension substance and a powdery substance, these solid substances are separated in advance, so that fluorine can be separated from such waste water and can thus be concentrated. Examples of such waste water include decomposition waste water. In addition to a PFC gas, a gas containing silica is introduced into the decomposition apparatus. Because of this fact, a large amount of silica particles are produced as a result of gas decomposition treatment, and are mixed into waste water. Examples of the decomposition apparatus include a combustion-type or thermal-type apparatus that produces waste water during operation.

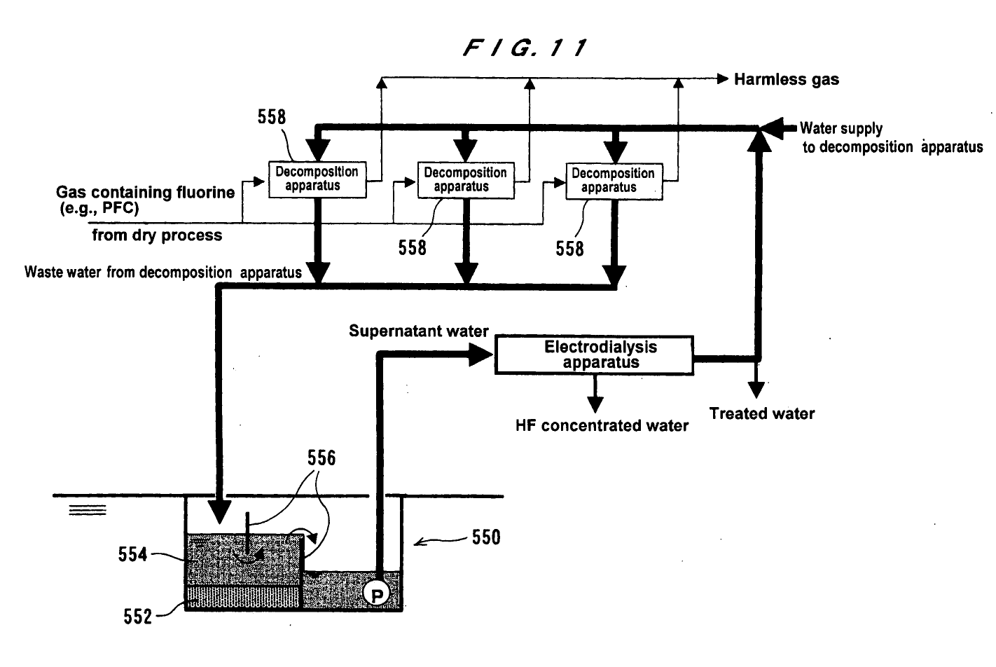

In a case of using such decomposition apparatus, it is preferable to use a fluorine treatment system in which the waste water containing fluorine is introduced into the liquid treatment apparatus via a solid-liquid separation device, such as a sedimentation-separation tank 550, as shown in FIG. 11. In FIG. 11, solid substances in the waste water precipitate out to form a sludge layer 552. In this system, supernatant water 554 is introduced into the liquid treatment apparatus. In this case, since the supernatant water 554 may contain a slight amount of suspended solid, it is preferable to provide a safety filter through which the supernatant water 554 is introduced into the liquid treatment apparatus. If the waste water possibly contains an organic substance, in order to avoid contamination of the ion exchange membrane in the liquid treatment apparatus by the organic substance, it is preferable to further provide an activated carbon treatment layer through which the supernatant water 554 is introduced into the liquid treatment apparatus.

Any known devices including a known film (filter) separation device and a known centrifugal separator can be used as the solid-liquid separation device, other than the sedimentation-separation tank 550. If the waste water contains a large amount of solid substances, it is preferable to use the sedimentation-separation tank 550 as the solid-liquid separation device. In FIG. 11, a plurality of partition plates 556 are provided for the purpose of preventing entry of the sludge 552 into the downstream side and for the purpose of causing the water to take a detour. Although the decomposition apparatus itself may have therein a solid-liquid separation tank or a filter for separating solid substances in the form of large particles, it is preferable to separately provide the above solid-liquid separation device downstream of the decomposition apparatus.

The treated water from the liquid treatment apparatus has a sufficiently lowered concentration of fluorine. Therefore, the treated water can be circulated as supply water of the decomposition apparatus 558, and the amount of water to be used can be small. Further, because part of the treated water is discharged from the liquid treatment apparatus, a small amount of substances can be prevented from being deposited in a system.

In a case where the waste water containing fluorine further contains organic substances, such as surfactant, these organic substances are separated in advance, so that fluorine can be separated from such waste water and can thus be concentrated. Examples of such waste water include waste water derived from hydrofluoric acid containing surfactant or buffered hydrofluoric acid (NH₄F), and waste water from a decomposition apparatus that is supplied with industrial water containing a slight amount of organic substances.

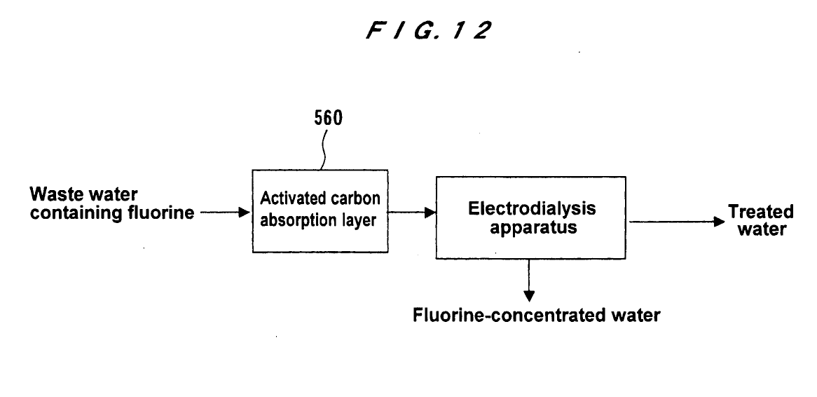

In this case also, as shown in FIG. 12, it is preferable to use a fluorine treatment system in which the waste water containing fluorine is introduced into the liquid treatment apparatus via an organic substance separation device, such as an activated carbon absorption layer 560. Instead of the activated carbon absorption layer, a known organic substance separation device, such as a membrane separation device, can be used as the organic substance separation device. In addition, a known organic substance decomposition device can also be used.

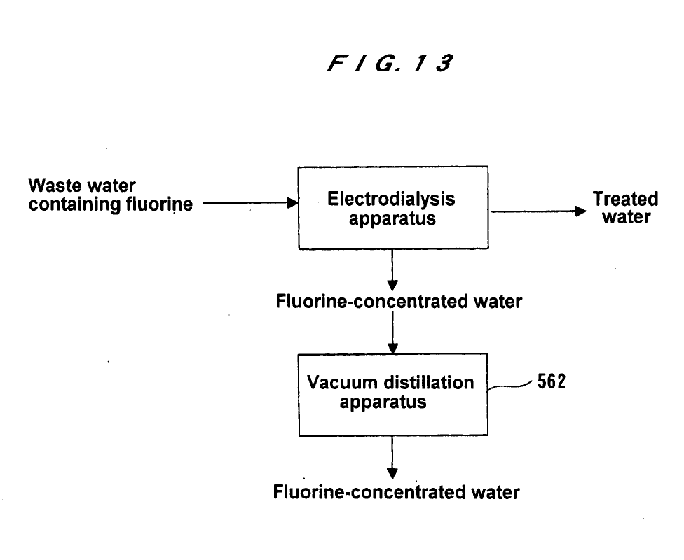

As shown in FIG. 13, it is possible to use a water evaporator, such as a vacuum distillation apparatus 562, so as to further increase the concentration of fluorine in the fluorine-concentrated water obtained from the liquid treatment apparatus according to the present invention. With this structure, even if the concentrated water has a concentration of 1000 to 10000 mg/l, the concentration of fluorine can be easily increased to more than 1 to 10%. Thus, this structure helps to increase the range of its reuse applications, e.g., acid cleaning of stainless steel in the iron and steel industry.

Next, the present invention will be more specifically described with reference to experimental examples. The following examples are provided to described specific applications of the present invention. Therefore, the present invention is not intended to be limited to the experimental examples described herein.

### EXAMPLE 1

Experiments were conducted with the liquid treatment apparatus shown in FIG. 1. Waste water discharged from semiconductor fabrication facilities was used as raw water. The raw water contained fluoride ions (100 mg-F/l) and ammonium ions (40 mg-N/l). Pure water was circulated as water to be concentrated. Pure water was also used as electrode liquids in the anode chamber 1 and the cathode chamber 4. The current density was 2 A/dm². Each of the raw water, water to be concentrated, water containing cations, and pure water had a space velocity (SV) of 50 to 100 [l/hr].

As a result of the experiments, the concentration of ammonium ions in treated water could be reduced to 1 to 3 mg/l. The operation voltage was as low as 18 V and in a stable state. Ammonium ions in the raw water were concentrated into ammonia water having a concentration of at least 1000 mg/l. Further, a hydrofluoric acid solution having a lowered concentration of ammonium ions (100 mg-F/l) could be obtained.

Non-woven cation exchange fabric
Base: a non-woven fabric made of polyethylene
Functional group: sulfo group
Production: by graft polymerization

Non-woven anion exchange fabric
Base: a non-woven fabric made of polyethylene
Functional group: quaternary ammonium group
Production: by graft polymerization

Cation exchange spacer
Base: a diagonal net made of polyethylene
Functional group: sulfo group
Production: by graft polymerization

Anion exchange spacer
Base: a diagonal net made of polyethylene
Functional group: quaternary ammonium group
Production: by graft polymerization

Anode: titanium plated with platinum
Form: a mesh lath

Cathode: SUS304
Form: a mesh lath

Cation exchange membrane: NEOSEPTA™ CMB (Astom Corp.)

Anion exchange membrane: NEOSEPTA™ AHA (Astom Corp.)

### EXAMPLE 2

Experiments were conducted with the liquid treatment apparatus shown in FIG. 2. The liquid treatment apparatus employed the same non-woven cation exchange fabrics 11, non-woven anion exchange fabrics 13, cation exchange spacer 12, anion exchange spacers 14, anode 6, cathode 7, cation exchange membrane C, and anion exchange membranes A as those in Example 1. Waste water discharged from semiconductor fabrication facilities was used as raw water. The raw water contained fluoride ions (500 mg-F/l). Pure water was circulated as water to be concentrated. Pure water was also used as electrode liquids in the anode chamber 1 and the cathode chamber 4. The current density was 3 A/dm². Each of the raw water, water to be concentrated, water containing anions, and pure water had a space velocity (SV) of 50 to 100 [l/hr].

As a result of the experiments, the treated water had a fluorine concentration of 1 to 3 mg/l. The operation voltage was as low as 17 V and in a stable state. Fluoride ions in the raw water were concentrated into hydrogen fluoride having a concentration of at least 10000 mg/l.

### EXAMPLE 3

Experiments were conducted with the liquid treatment apparatus shown in FIG. 3. The liquid treatment apparatus employed the same non-woven cation exchange fabrics 11, non-woven anion exchange fabrics 13, cation exchange spacer 12, anion exchange spacer 14, anode 6, cathode 7, cation exchange membranes C, and anion exchange membranes A as those in Example 1. Waste water discharged from semiconductor fabrication facilities was used as raw water. The raw water contained copper ions (50 mg-Cu/l). A sulfuric acid solution having a pH of 1.5 was used as a liquid containing anions. A sulfuric acid solution having a pH of 1.5 was circulated as water to be concentrated. Pure water was used as electrode liquids in the anode chamber 1 and the cathode chamber 4. The current density was 2 A/dm². Each of the raw water, water to be concentrated, water containing anions, and pure water had a space velocity (SV) of 100 [l/hr].

As a result of the experiments, the treated water had a copper concentration of 2 to 3 mg/l. The operation voltage was as low as 20 V and in a stable state. Copper ions in the raw water were concentrated into a copper sulfate solution having a concentration of at least 5000 mg/l. Thus, hydroxide ions produced on the cathode by electrolysis of pure water could be replaced with sulfate ions, and the sulfate ions could be concentrated. The concentrated water contained no anions other than hydroxide ions and sulfate ions.

### EXAMPLE 4

Experiments were conducted with the liquid treatment apparatus shown in FIG. 5. The liquid treatment apparatus employed the same non-woven cation exchange fabrics 11, non-woven anion exchange fabrics 13, cation exchange spacer 12, anion exchange spacer 14, anode 6, cathode 7, cation exchange membranes C, and anion exchange membranes A as those in Example 1. Waste water discharged from semiconductor fabrication facilities was used as raw water. The raw water contained copper ions (50 mg-Cu/l). A sulfuric acid solution having a pH of 1.5 was used as a liquid containing anions. A sulfuric acid solution having a pH of 1.5 was circulated as water to be concentrated. Pure water was used as electrode liquids in the anode chamber 1 and the cathode chamber 4. The current density was 2 A/dm². The raw water had a space velocity (SV) of 50 [l/hr]. Each of the water to be concentrated, water containing anions, and pure water had a space velocity (SV) of 100 [l/hr].

As a result of the experiments, the treated water had a copper concentration less than 0.1 mg/l. The operation voltage was as low as 23 V and in a stable state. Copper ions in the raw water were concentrated into a copper sulfate solution having a concentration of at least 5000 mg/l. Thus, it was proved that process performance can be improved when raw water is supplied to two deionization chambers in series. The concentrated water contained no anions other than hydroxide ions and sulfate ions.

### EXAMPLE 5

Experiments were conducted with the liquid treatment apparatus having a bipolar electrode structure shown in FIG. 6. The liquid treatment apparatus employed the same non-woven cation exchange fabrics 11, non-woven anion exchange fabrics 13, cation exchange spacer 12, anion exchange spacer 14, anode 6, cathode 7, cation exchange membranes C, and anion exchange membranes A as those in Example 1. Waste water discharged from semiconductor fabrication facilities was used as raw water. The raw water contained fluoride ions (500 mg-F/l). Pure water was circulated as water to be concentrated. Pure water was also used as electrode liquids in the anode chamber 1, the cathode chamber 4, and the bipolar electrode chamber. A non-woven anion exchange fabric A, an electrode in the form of a mesh lath, and a non-woven cation exchange fabric 11 were filled in the bipolar electrode chamber in the order from the anode 6. The electrode was made of titanium plated with platinum. The current density was 3 A/dm². Each of the raw water, water to be concentrated, water containing anions, and pure water had a space velocity (SV) of 50 to 100 [l/hr].

As a result of the experiments, the treated water had an ammonium ion concentration of 1 to 3 mg/l. The operation voltage was as low as 40 V and in a stable state. Fluoride ions in the raw water were concentrated into hydrogen fluoride having a concentration of at least 10000 mg/l. Under the same conditions as Example 2, the amount of treated water could be doubled.

### EXAMPLE 6

Experiments were conducted with the liquid treatment apparatus shown in FIG. 2. The liquid treatment apparatus employed the same non-woven cation exchange fabrics 11, non-woven anion exchange fabrics 13, cation exchange spacer 12, anion exchange spacer 14, anode 6, cathode 7, cation exchange membranes C, and anion exchange membranes A as those in Example 1. A platinum plating solution (sulfuric acid concentration of about 150 g-H₂SO₄/l, platinum concentration of about 5 g/l) was used as raw water. Pure water was circulated as water to be concentrated. Pure water was also used as electrode liquids in the anode chamber 1 and the cathode chamber 4. The current density was 2 A/dm². Each of the raw water, water to be concentrated, water containing anions, and pure water had a space velocity (SV) of 50 [l/hr].

As a result of the experiments, the concentration of sulfuric acid in the concentrated water was increased to 5%. Thus, it was proved that the liquid treatment apparatus is also applicable to a case where sulfuric acid is separated from a platinum plating solution.

### INDUSTRIAL APPLICABILITY

The present invention is suitable for use in a liquid treatment apparatus for separating cations, such as copper ions or ammonium ions, or anions, such as fluoride ions or sulfate ions, from a liquid.

1. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber;
a neutralization chamber disposed between said cathode chamber and said anode chamber, said neutralization chamber being configured to receive the removed ions and electrically neutralize the removed ions by ions supplied from said anode chamber or said cathode chamber; and
an ion exchange membrane to partition said deionization chamber and said neutralization chamber,
an ion exchanger disposed in at least one of said cathode chamber and said anode chamber.

2. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber;
a neutralization chamber disposed between said cathode chamber and said anode chamber, said neutralization chamber being configured to receive the removed ions and electrically neutralize the ions having the same charge as the ions supplied from said anode chamber or said cathode chamber;
an ion exchange membrane to partition said deionization chamber and said neutralization chamber, and
an ion exchanger disposed in at least one of said cathode chamber and said anode chamber.

3. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber;
a neutralization chamber disposed between said cathode chamber and said anode chamber, said neutralization chamber being configured to receive the removed ions and electrically neutralize the removed ions by ions supplied from said anode chamber or said cathode chamber; and
an ion exchange membrane to partition said deionization chamber and said neutralization chamber,
wherein at least one of said anode chamber and said cathode chamber is supplied with pure water.

4. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber;
a neutralization chamber disposed between said cathode chamber and said anode chamber, said neutralization chamber being configured to receive the removed ions and electrically neutralize the ions having the same charge as the ions supplied from said anode chamber or said cathode chamber; and
an ion exchange membrane to partition said deionization chamber and said neutralization chamber,
wherein at least one of said anode chamber and said cathode chamber is supplied with pure water.

5. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber; and
a neutralization chamber disposed between said cathode chamber and said anode chamber, said neutralization chamber being configured to receive the removed ions and electrically neutralize the removed ions by ions supplied from said anode chamber or said cathode chamber;
an ion exchange membrane to partition said deionization chamber and said neutralization chamber,
wherein at least one of said anode chamber and said cathode chamber is supplied with a non-electrolyte solution.

6. A liquid treatment apparatus comprising:
a cathode chamber having a cathode disposed therein;
an anode chamber having an anode disposed therein;
a deionization chamber disposed between said cathode chamber and said anode chamber, said deionization chamber being configured to selectively remove anions or cations from a water to be treated and receive ions having the same charge as the selectively removed ions from said cathode chamber or said anode chamber; and
a neutralization chamber disposed between said cathode chamber and said anode chamber, said neutralization chamber being configured to receive the removed ions and electrically neutralize the ions having the same charge as the ions supplied from said anode chamber or said cathode chamber;
an ion exchange membrane to partition said deionization chamber and said neutralization chamber,
wherein at least one of said anode chamber and said cathode chamber is supplied with a non-electrolyte solution.

7. The liquid treatment apparatus as recited in claim 1, further comprising an ion exchanger disposed in at least one of said deionization chamber and said neutralization chamber.

8. The liquid treatment apparatus as recited in claim 1, wherein at least one of said anode chamber and said cathode chamber is supplied with pure water.

9. The liquid treatment apparatus as recited in claim 1, wherein at least one of said anode chamber and said cathode chamber is supplied with a non-electrolyte solution.

10. A fluorine treatment system comprising:
a liquid treatment apparatus according to claim 1 for treating waste water containing at least fluorine; and
a fluorine recycling apparatus for recovering fluorine-concentrated water as calcium fluoride, the fluorine-concentrated water being obtained from said liquid treatment apparatus.

11. A fluorine treatment system comprising:
a liquid treatment apparatus according to claim 1 for treating waste water containing at least fluorine; and
a coagulation-sedimentation apparatus for performing coagulation-sedimentation treatment on water containing at least part of fluorine-concentrated water obtained from said liquid treatment apparatus.

12. A water recycling system comprising:
a liquid treatment apparatus according to claim 1; and
a pure water production apparatus for producing pure water from treated water obtained from said liquid treatment apparatus.

13. A water recycling system comprising:
a liquid treatment apparatus according to claim 1;
a decomposition apparatus;
a passage configured to supply waste water from said decomposition apparatus to said liquid treatment apparatus; and
a passage configured to supply part of treated water obtained from said liquid treatment apparatus to said decomposition apparatus.

14. A fluorine treatment system comprising:
a liquid treatment apparatus according to claim 1;
a solid-liquid separation device for separating a solid substance from waste water containing at least fluorine; and
a passage configured to supply the separated waste water from said solid-liquid separation device to said liquid treatment apparatus.

15. A fluorine treatment system comprising:
a liquid treatment apparatus according to claim 1;
an organic substance separation device for separating an organic substance from waste water containing at least fluorine; and
a passage configured to supply the separated waste water from said organic substance separation device to said liquid treatment apparatus.

16. The liquid treatment apparatus as recited in claim 2, further comprising an ion exchanger disposed in at least one of said deionization chamber and said neutralization chamber.

17. The liquid treatment apparatus as recited in claim 3, further comprising an ion exchanger disposed in at least one of said deionization chamber and said neutralization chamber.

18. The liquid treatment apparatus as recited in claim 4, further comprising an ion exchanger disposed in at least one of said deionization chamber and said neutralization chamber.

19. The liquid treatment apparatus as recited in claim 5, further comprising an ion exchanger disposed in at least one of said deionization chamber and said neutralization chamber.

20. The liquid treatment apparatus as recited in claim 6, further comprising an ion exchanger disposed in at least one of said deionization chamber and said neutralization chamber.

21. The liquid treatment apparatus as recited in claim 2, wherein at least one of said anode chamber and said cathode chamber is supplied with pure water.

22. The liquid treatment apparatus as recited in claim 5, wherein at least one of said anode chamber and said cathode chamber is supplied with pure water.

23. The liquid treatment apparatus as recited in claim 6, wherein at least one of said anode chamber and said cathode chamber is supplied with pure water.

24. The liquid treatment apparatus as recited in claim 2, wherein at least one of said anode chamber and said cathode chamber is supplied with a non-electrolyte solution.

25. The liquid treatment apparatus as recited in claim 3, wherein at least one of said anode chamber and said cathode chamber is supplied with a non-electrolyte solution.

26. The liquid treatment apparatus as recited in claim 4, wherein at least one of said anode chamber and said cathode chamber is supplied with a non-electrolyte solution.

27. A fluorine treatment system comprising:
a liquid treatment apparatus according to claim 2 for treating waste water containing at least fluorine; and
a fluorine recycling apparatus for recovering fluorine-concentrated water as calcium fluoride, the fluorine-concentrated water being obtained from said liquid treatment apparatus.

28. A fluorine treatment system comprising:
a liquid treatment apparatus according to claim 3 for treating waste water containing at least fluorine; and
a fluorine recycling apparatus for recovering fluorine-concentrated water as calcium fluoride, the fluorine-concentrated water being obtained from said liquid treatment apparatus.

29. A fluorine treatment system comprising:
a liquid treatment apparatus according to claim 4 for treating waste water containing at least fluorine; and
a fluorine recycling apparatus for recovering fluorine-concentrated water as calcium fluoride, the fluorine-concentrated water being obtained from said liquid treatment apparatus.

30. A fluorine treatment system comprising:
a liquid treatment apparatus according to claim 5 for treating waste water containing at least fluorine; and
a fluorine recycling apparatus for recovering fluorine-concentrated water as calcium fluoride, the fluorine-concentrated water being obtained from said liquid treatment apparatus.

31. A fluorine treatment system comprising:
a liquid treatment apparatus according to claim 6 for treating waste water containing at least fluorine; and
a fluorine recycling apparatus for recovering fluorine-concentrated water as calcium fluoride, the fluorine-concentrated water being obtained from said liquid treatment apparatus.

32. A fluorine treatment system comprising:
a liquid treatment apparatus according to claim 2 for treating waste water containing at least fluorine; and
a coagulation-sedimentation apparatus for performing coagulation-sedimentation treatment on water containing at least part of fluorine-concentrated water obtained from said liquid treatment apparatus.

33. A fluorine treatment system comprising:
a liquid treatment apparatus according to claim 3 for treating waste water containing at least fluorine; and
a coagulation-sedimentation apparatus for performing coagulation-sedimentation treatment on water containing at least part of fluorine-concentrated water obtained from said liquid treatment apparatus.

34. A fluorine treatment system comprising:
a liquid treatment apparatus according to claim 4 for treating waste water containing at least fluorine; and
a coagulation-sedimentation apparatus for performing coagulation-sedimentation treatment on water containing at least part of fluorine-concentrated water obtained from said liquid treatment apparatus.

35. A fluorine treatment system comprising:
a liquid treatment apparatus according to claim 5 for treating waste water containing at least fluorine; and
a coagulation-sedimentation apparatus for performing coagulation-sedimentation treatment on water containing at least part of fluorine-concentrated water obtained from said liquid treatment apparatus.

36. A fluorine treatment system comprising:
a liquid treatment apparatus according to claim 6 for treating waste water containing at least fluorine; and
a coagulation-sedimentation apparatus for performing coagulation-sedimentation treatment on water containing at least part of fluorine-concentrated water obtained from said liquid treatment apparatus.

37. A water recycling system comprising:
a liquid treatment apparatus according to claim 2; and
a pure water production apparatus for producing pure water from treated water obtained from said liquid treatment apparatus.

38. A water recycling system comprising:
a liquid treatment apparatus according to claim 3; and
a pure water production apparatus for producing pure water from treated water obtained from said liquid treatment apparatus.

39. A water recycling system comprising:
a liquid treatment apparatus according to claim 4; and
a pure water production apparatus for producing pure water from treated water obtained from said liquid treatment apparatus.

40. A water recycling system comprising:
a liquid treatment apparatus according to claim 5; and
a pure water production apparatus for producing pure water from treated water obtained from said liquid treatment apparatus.

41. A water recycling system comprising:
a liquid treatment apparatus according to claim 6; and
a pure water production apparatus for producing pure water from treated water obtained from said liquid treatment apparatus.

42. A water recycling system comprising:
a liquid treatment apparatus according to claim 2;
a decomposition apparatus;
a passage configured to supply waste water from said decomposition apparatus to said liquid treatment apparatus; and
a passage configured to supply part of treated water obtained from said liquid treatment apparatus to said decomposition apparatus.

43. A water recycling system comprising:
a liquid treatment apparatus according to claim 3;
a decomposition apparatus;
a passage configured to supply waste water from said decomposition apparatus to said liquid treatment apparatus; and
a passage configured to supply part of treated water obtained from said liquid treatment apparatus to said decomposition apparatus.

44. A water recycling system comprising:
a liquid treatment apparatus according to claim 4;
a decomposition apparatus;
a passage configured to supply waste water from said decomposition apparatus to said liquid treatment apparatus; and
a passage configured to supply part of treated water obtained from said liquid treatment apparatus to said decomposition apparatus.

45. A water recycling system comprising:
a liquid treatment apparatus according to claim 5;
a decomposition apparatus;
a passage configured to supply waste water from said decomposition apparatus to said liquid treatment apparatus; and
a passage configured to supply part of treated water obtained from said liquid treatment apparatus to said decomposition apparatus.

46. A water recycling system comprising:
a liquid treatment apparatus according to claim 6;
a decomposition apparatus;
a passage configured to supply waste water from said decomposition apparatus to said liquid treatment apparatus; and
a passage configured to supply part of treated water obtained from said liquid treatment apparatus to said decomposition apparatus.

47. A fluorine treatment system comprising:
a liquid treatment apparatus according to claim 2;
a solid-liquid separation device for separating a solid substance from waste water containing at least fluorine; and
a passage configured to supply the separated waste water from said solid-liquid separation device to said liquid treatment apparatus.

48. A fluorine treatment system comprising:
a liquid treatment apparatus according to claim 3;
a solid-liquid separation device for separating a solid substance from waste water containing at least fluorine; and
a passage configured to supply the separated waste water from said solid-liquid separation device to said liquid treatment apparatus.

49. A fluorine treatment system comprising:
a liquid treatment apparatus according to claim 4;
a solid-liquid separation device for separating a solid substance from waste water containing at least fluorine; and
a passage configured to supply the separated waste water from said solid-liquid separation device to said liquid treatment apparatus.

50. A fluorine treatment system comprising:
a liquid treatment apparatus according to claim 5;
a solid-liquid separation device for separating a solid substance from waste water containing at least fluorine; and
a passage configured to supply the separated waste water from said solid-liquid separation device to said liquid treatment apparatus.

51. A fluorine treatment system comprising:
a liquid treatment apparatus according to claim 6;
a solid-liquid separation device for separating a solid substance from waste water containing at least fluorine; and
a passage configured to supply the separated waste water from said solid-liquid separation device to said liquid treatment apparatus.

52. A fluorine treatment system comprising:
a liquid treatment apparatus according to claim 2;
an organic substance separation device for separating an organic substance from waste water containing at least fluorine; and
a passage configured to supply the separated waste water from said organic substance separation device to said liquid treatment apparatus.

53. A fluorine treatment system comprising:
a liquid treatment apparatus according to claim 3;
an organic substance separation device for separating an organic substance from waste water containing at least fluorine; and
a passage configured to supply the separated waste water from said organic substance separation device to said liquid treatment apparatus.

54. A fluorine treatment system comprising:
a liquid treatment apparatus according to claim 4;
an organic substance separation device for separating an organic substance from waste water containing at least fluorine; and
a passage configured to supply the separated waste water from said organic substance separation device to said liquid treatment apparatus.

55. A fluorine treatment system comprising:
a liquid treatment apparatus according to claim 5;
an organic substance separation device for separating an organic substance from waste water containing at least fluorine; and
a passage configured to supply the separated waste water from said organic substance separation device to said liquid treatment apparatus.

56. A fluorine treatment system comprising:
a liquid treatment apparatus according to claim 6;
an organic substance separation device for separating an organic substance from waste water containing at least fluorine; and
a passage configured to supply the separated waste water from said organic substance separation device to said liquid treatment apparatus.
